(19) United States
(12) Patent Application Publication
(10) Pub. No.: US 2014/0012745 A1
(43) Pub. Date: Jan. 9, 2014

(54) FUTURE ACCOUNT VIEW

(71) Applicants: Carrie Anne Hanson, Charlotte, NC (US); Scott R. Enscoe, Charlotte, NC (US); Alexander C. Wittkowski, Charlotte, NC (US); Laura Corrine Bondensen, Charlotte, NC (US); Leland E. Modesitt, III, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(72) Inventors: Carrie Anne Hanson, Charlotte, NC (US); Scott R. Enscoe, Charlotte, NC (US); Alexander C. Wittkowski, Charlotte, NC (US); Laura Corrine Bondensen, Charlotte, NC (US); Leland E. Modesitt, III, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/543,696

(22) Filed: Jul. 6, 2012

(51) Int. Cl. G06Q 20/08

(52) U.S. Cl. 705/40

(57) ABSTRACT

Embodiments of the invention are directed to systems, methods and computer program products enabling a user of an account to pictorially view available funds over a predetermined period in the future and thereby enable informed bill payment scheduling. In some embodiments, a method comprises determining, for a predetermined period in the future, at least one bill payment to be made using funds associated with the account; initiating, via a mobile network, presentation of a graphical indicator indicating the at least one bill payment; and initiating, via the mobile network, presentation of an account balance graph associated with the account based at least partially on the at least one bill payment, wherein the account balance graph indicates the account balance during the predetermined period in the future.

### BACKGROUND

People usually resort to mental calculations to determine how much money they can spend in the near future. There is a need for a system that enables a person to view a future balance of an account without resorting to mental calculations.

### BRIEF SUMMARY

Embodiments of the invention are directed to systems, methods and computer program products for initiating presentation of a future view of an account. In some embodiments, an apparatus is provided for initiating presentation of a future view of an account. The apparatus comprises: a memory; a processor; and a module stored in the memory, executable by the processor, and configured to: determine, for a predetermined period in the future, at least one bill payment to be made using funds associated with the account; initiate, via a mobile network, presentation of a first graphical indicator indicating the at least one bill payment; and initiate, via the mobile network, presentation of an account balance graph associated with the account based at least partially on the at least one bill payment, wherein the account balance graph indicates the account balance during the predetermined period in the future.

In some embodiments, the module is further configured to: determine, for the predetermined period in the future and based on previous expenses satisfied using funds associated with the account, at least one expense to be satisfied using funds associated with the account; and initiate, via the mobile network, presentation of the account balance graph based at least partially on the at least one bill payment and the at least one expense.

In some embodiments, the module is further configured to initiate, via a mobile network, presentation of a second graphical indicator indicating the at least one expense.

In some embodiments, the module is further configured to: determine, for the predetermined period in the future and based on previous funds transfers into the account, at least one funds transfer into the account; and initiate, via the mobile network, presentation of the account balance graph based at least partially on the at least one bill payment and the at least funds transfer.

In some embodiments, the module is further configured to initiate, via a mobile network, presentation of a third graphical indicator indicating the at least one funds transfer into the account.

In some embodiments, the at least one bill payment is determined based on previous bill payments made using funds associated with the account.

In some embodiments, the at least one bill payment is determined based on manual input.

In some embodiments, the at least one bill payment is determined based on established electronic link between the account and a merchant.

In some embodiments, when the first graphical indicator is selected, the module is configured to initiate presentation of information associated with the at least one bill payment, the information comprising at least one of a description associated with the bill payment, a due date associated with the bill payment, or an amount associated with the bill payment.

In some embodiments, the module is further configured to initiate presentation of a fourth graphical indicator, wherein when the fourth graphical indicator is selected, the module is configured to: initiate presentation of the first graphical indicator indicating the at least one bill payment; and modify the account balance graph.

In some embodiments, modifying the account balance graph comprises hiding the account balance graph.

In some embodiments, when the account balance graph indicates the account balance falls below a predetermined threshold balance during the predetermined period in the future, the module is configured to initiate presentation of an option to select a bridge loan for a predetermined loan period.

In some embodiments, the predetermined loan period extends until the account is determined to receive an amount of funds causing the account balance to rise above the predetermined threshold balance.

In some embodiments, when the bridge loan option is selected, the module is configured to initiate presentation of information regarding the bridge loan.

In some embodiments, the module is configured to initiate presentation of the option to select the bridge loan for the predetermined loan period when the user selects at least one of a portion of the account balance graph corresponding to the account balance falling below the predetermined threshold balance or a bill payment indicator located on the portion of the account balance graph corresponding to the account balance falling below the predetermined threshold balance.

In some embodiments, when the account balance graph indicates the account balance falls below a predetermined threshold balance during the predetermined period in the future, the module is configured to initiate presentation of an option to transfer funds from another account to the account.

In some embodiments, the module is further configured to initiate presentation of a fifth graphical indicator, wherein when the fifth graphical indicator is selected, the module is configured to: initiate presentation of the second graphical indicator indicating the at least one expense; and modify the account balance graph.

In some embodiments, the module is further configured to initiate presentation of a sixth graphical indicator, wherein when the sixth graphical indicator is selected, the module is configured to: initiate presentation of the third graphical indicator indicating the at least one funds transfer into the account; and modify the account balance graph.

In some embodiments, the account balance graph is presented on a mobile device.

In some embodiments, the module is further configured to initiate presentation of at least one suggestion to optimize use of funds associated with the account.

In some embodiments, a method is provided for initiating presentation of a future view of an account. The method comprises: determining, for a predetermined period in the future, at least one bill payment to be made using funds associated with the account; initiating, via a mobile network, presentation of a graphical indicator indicating the at least one bill payment; and initiating, via the mobile network, presentation of an account balance graph associated with the account based at least partially on the at least one bill payment, wherein the account balance graph indicates the account balance during the predetermined period in the future.

In some embodiments, a computer program product is provided for initiating presentation of a future view of an account. The computer program product comprises a non-transitory computer-readable medium comprising a set of codes for causing a computer to: determine, for a predetermined period in the future, at least one bill payment to be made using funds associated with the account; initiate, via a mobile network, presentation of a graphical indicator indicating the at least one bill payment; and initiate, via the mobile network, presentation of an account balance graph associated with the account based at least partially on the at least one bill payment, wherein the account balance graph indicates the account balance during the predetermined period in the future.

### BRIEF DESCRIPTION OF THE DRAWINGS

Having thus described embodiments of the invention in general terms, reference will now be made to the accompanying drawings, where:

FIG. 1 is a flowchart illustrating a general process flow for initiating presentation of a future view of an account, in accordance with embodiments of the present invention;

FIG. 2 is a user interface presenting a future view of an account, in accordance with embodiments of the present invention;

FIG. 3 is another user interface presenting a future view of an account, in accordance with embodiments of the present invention;

FIG. 4 is another user interface presenting a future view of an account, in accordance with embodiments of the present invention; and

FIG. 5 is a block diagram illustrating technical components of a system for initiating presentation of a future view of an account, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for initiating presentation of a future view of an account. Embodiments of the invention provide a graphical representation of funds associated with an account over a period of time in the future. Embodiments of the invention also provide a graphical representation of predicted or scheduled bill payments and/or expenses over a period of time in the future. As used herein, a bill payment is a payment associated with a recurring transaction (e.g., utilities payment). As used herein, an expense is a payment associated with a one-time purchase (e.g., grocery purchase). Therefore, the account balance varies based on the bill payments and/or expenses that cause reduction of funds in the account. Transactions associated with bill payment and expense payment may be referred to as funds transfers out of the account. Additionally, the account balance varies over period of time based on predicted influx of funds into the account.

These predictions may be made based on historical transactions (e.g., bill payments, expenses, funds influx, etc.) associated with the account. Additionally or alternatively, these predictions may be made based on user input (e.g., the user inputs a date on which a particular bill is due). Additionally or alternatively, these predictions may be made based on electronic bill payment invoices that are transmitted to the account from a source (e.g., a utilities company). These electronic bill payment invoices may be transmitted to a bill control or bill management service associated with the account. In some embodiments, a user establishes an electronic link between the account and a merchant for automatic receipt and/or payment of the bill. Therefore, embodiments of the invention enable bill due date management and bill payment management without resorting to mental calculations regarding a future balance of an account.

When a user of an account manually schedules bill payments, the graphical representation of funds enables informed bill payment scheduling because the user can view how the account balance changes over time. Therefore, the user may schedule bill payments such that the account balance does not fall below a predetermined balance of funds (e.g., zero). Additionally, the user may schedule bill payments at an optimal time (e.g., when the account is indicated as having maximum funds or soon after a transfer of funds is received into the account). Additionally, if several bill payments are scheduled for a certain date, the user may reschedule some of the bill payments in order to scatter the bill payments over a period of time (e.g., a month). Additionally, if the graphical representation of the account balance indicates that the account balance will fall below a threshold balance (e.g., zero) on a certain date in the future, the user can establish a plan to transfer funds into the account prior to the day the account balance is indicated to fall below the predetermined threshold, or the user can delay a scheduled bill payment to prevent the account balance from falling below the predetermined threshold. Additionally, in some embodiments, the system described herein initiates presentation of options (e.g., a bridge loan option) to prevent the account balance from falling below the predetermined threshold. Thus, the graphical representation of the account balance along with the predicted or scheduled bill payments, expenses, and funds influxes may be used by the user as a day-to-day financial planning tool.

The invention addresses perceived accuracy limitations of account management via a mobile device. Additionally, the invention reduces service calls from users requesting help in managing issues associated with account management. The invention also helps to increase mobile adoption of services provided by a financial institution and reduces the cost associated with account management to both the user and the financial institution.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the entity. In other embodiments, an entity may not be a financial institution. In still other embodiments, the entity may be the merchant itself (e.g., the merchant that transmits a bill to the user).

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded).

As used herein, a mobile device may be any portable mobile communication or computing device. As used herein, a user interface is a user interface associated with a mobile device. As used herein, a mobile network may be any network (e.g., data network, communication network, etc.) via which the mobile device connects to a financial institution account or to the future account view feature or service associated with the financial institution account. The network may be a local area network (LAN), a wide area network (WAN), and/or a global area network (GAN), such as the Internet. The network may be secure and/or unsecure and may also include wireless and/or wireline and/or optical interconnection technology.

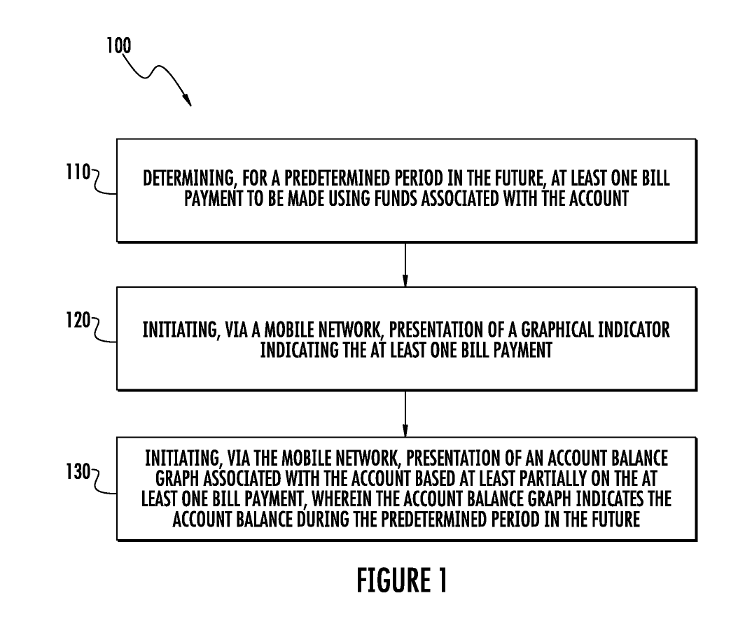

Referring now to FIG. 1, a general process flow 100 is provided for initiating presentation of a future view of an account. At block 110, the method comprises determining, for a predetermined period in the future, at least one bill payment to be made using funds associated with the account. At block 120, the method comprises initiating, via a mobile network, presentation of a graphical indicator (e.g., a dot) indicating the at least one bill payment. At block 130, the method comprises initiating, via the mobile network, presentation of an account balance graph associated with the account based at least partially on the at least one bill payment, wherein the account balance graph indicates the account balance during the predetermined period in the future.

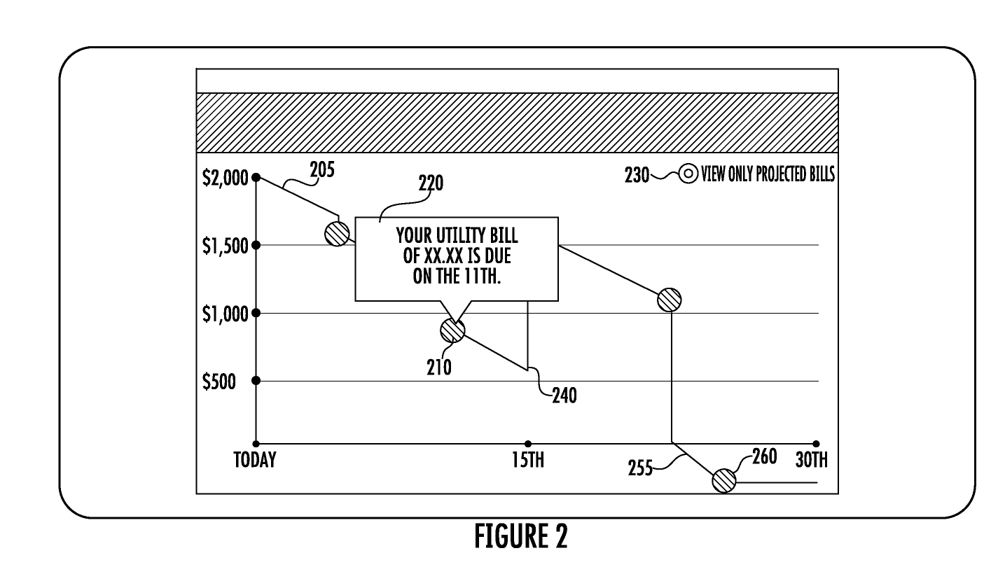

Referring now to FIG. 2, FIG. 2 is a user interface presenting a future view of an account, in accordance with embodiments of the present invention. In some embodiments, a user authenticates into a financial institution account in order to access the “future view” service. When the user accesses this service, the system initiates graphical presentation of a user interface that indicates the account's balance over a predetermined period of time (e.g., from today to the next 30 days). As indicated in FIG. 2, an account balance graph is presented where the account balance is on the y-axis and the date is on the x-axis. Additionally, as indicated in FIG. 2, a part 255 of the graph corresponding to a time period when the account balance is less than or equal to a predetermined threshold (e.g., zero) is presented in a different color from a part 205 of the graph corresponding to a time period when the account balance is greater than the predetermined threshold. Therefore, for example, the account balance graph 205 is colored green for the period when the account balance is greater than the predetermined threshold, and the account balance graph 255 is colored red for the period when the account balance is less than or equal to the predetermined threshold.

The graphical presentation of the account balance is based on predicted or scheduled bill payments to be made using funds from the account, predicted expenses to be satisfied using funds from the account, predicted funds transfers (e.g., a recurring salary) into the account, etc. The expenses, bill payments, and funds transfers may be predicted based on historical expenses, bill payments, and funds transfers into the account (e.g., expenses, bill payments, funds transfers during the preceding six months). Additionally or alternatively, in some embodiments, the bill payments may be manually scheduled by a user (e.g., the user schedules a bill payment for the fifteenth of every month). Additionally or alternatively, the bill payments may be based on bill payment invoices that are electronically received into the account from a source (e.g., a utilities company). Therefore, the user may have configured the financial institution account such that the user's account is electronically linked to the user's utilities account such that the financial institution account is configured to automatically pay the amount of the utilities bill on a particular date each month (e.g., a user-selected date, the date the bill is received, the due date of the bill, etc.).

In some embodiments, each instance of a predicted or scheduled bill payment is indicated using a graphical indicator 210. In some embodiments, each instance of a predicted expense and/or a funds transfer into the account is also indicated using a graphical indicator. In some embodiments, the type of graphical indicator used for each type of transaction may be different. For example, a first color is used for a graphical indicator for a predicted or scheduled bill payment and a second color is used for a graphical indicator for a predicted expense or funds transfer. In some embodiments, a first color is used for the graphical indicator for a predicted bill payment (e.g., predicted based on historical bill payments) and a second color is used for the graphical indicator for a scheduled bill payment (e.g., manually scheduled by the user or electronically linked to a merchant source). As a further example, a first color (e.g., green) is used for a predicted or scheduled bill payment 210 when the account balance is greater than predetermined threshold, and a second color (e.g., red) is used for a predicted or scheduled bill payment 260 when the account balance is less than or equal to the predetermined threshold.

Each of the graphical indicators described herein is selectable. For example, the user may select the indicator by touching the indicator, clicking on the indicator, or hovering over the indicator for a predetermined period of time. When the graphical indicator is selected, the system is configured to initiate presentation of information associated with the bill. When the graphical indicator is a graphical indicator for a bill payment, a window 220 (e.g., a pop-up window) is presented indicating the description of the bill (e.g., utilities bill), an amount of the bill, a due date of the bill, a date on which the bill is scheduled to be paid, etc. The due date of the bill may or may not be the date on which the bill is scheduled to be paid (e.g., the bill may be scheduled to be paid before the due date). In some embodiments, when the graphical indicator is selected, the graphical indicator may change its form (e.g., change shape or color).

In some embodiments, if the window 220 does not indicate a date other than the due date, then the bill is scheduled or predicted to be paid on the due date. In some embodiments, the bill is automatically scheduled to be paid on the due date (or the date on which the bill is scheduled to be paid) such that funds are automatically transferred out of the user's financial institution account on the due date (or the date on which the bill is scheduled to be paid) without manual intervention. In other embodiments, the user has to manually pay the bill on the due date (or the date on which the bill is scheduled to be paid). In such embodiments, a bill management feature associated with the financial institution account may send a reminder to the user on or prior to the due date (or the date on which the bill is scheduled to be paid). The reminder may be sent via any of a number of communication mechanisms (e.g., email, voicemail, text message, phone call, etc.). Subsequently, the user pays the bill by selecting an option to pay the bill by electronically transferring funds out of the user's financial institution account.

Additionally, as indicated on the user interface in FIG. 2, an option 230 (e.g., a selectable button) is presented to view only projected bills. As used herein, the terms “project” and “predict” may be used interchangeably. Additionally or alternatively, in some embodiments, an option may be presented to view only projected expenses. Additionally or alternatively, in some embodiments, an option may be presented to view only funds transfers into the account. Additionally or alternatively, in some embodiments, an option may be presented to view a combination of at least one of bills, expenses, or funds transfers into the account.

As indicated in FIG. 2, the node 240 is when the account is predicted to receive funds (e.g., a salary) into the account. This causes the account balance to increase on the fifteenth of the month.

In some embodiments, when a user selects a graphical indicator 210 associated with a predicted or scheduled bill payment, the resulting window includes options to pay the bill. Exemplary options include options to pay the bill instantly, pay the bill a predetermined period after a payment is credited to the financial institution account, pay the bill on a day when the bill is due, pay the bill based on a customized schedule determined by a user of the financial institution account, present a reminder to the user after a predetermined period or a predetermined period before the bill is due, etc. Exemplary options also include an option to select an account from which to pay the bill. The mobile device communicates information to the merchant either directly from the mobile device via a network, or via a system (e.g., external server) associated with the financial institution. The mobile device may send information to the merchant regarding the user's handling of the bill. For example, the mobile device may send a message to the merchant when the user views a bill associated with the merchant on the user's mobile device. Additionally, the mobile device may send a message to the merchant when the user selects an option to pay the bill. The message may include information associated with how the user will pay for the bill (e.g., the date of payment, the number of installments for payment, payment amount, payment method, etc.).

As an example, when a user pays a bill immediately, information associated with the bill payment is communicated from the mobile device to the merchant so that the merchant knows how much the user has paid, the method of payment, etc. This information is useful to the merchant because the merchant may not receive the paid amount from the financial institution until the user's bill payment is processed and the funds are settled. As another example, when a user schedules a bill payment for a predetermined date in the future, this information is communicated to the merchant so that the merchant knows when to expect the bill payment from the user. As a further example, when the user inputs the payment method as a first type of payment method (e.g., debit card), the merchant may send a message (via email, text message, social networking message, etc.) to the user indicating alternate options (e.g., electronic funds transfer) to pay the bill. As a further example, the merchant's message may indicate that the user will receive a discount (and may indicate the discount amount) and/or other rewards (e.g., reward points) if the user pays via one of the alternate options proposed by the merchant. As a further example, when the user inputs a payment amount different from the bill amount, the merchant may send a message to the user indicating that the user has chosen to pay an amount different from the bill amount. In some embodiments, the user may select an option to pay via foreign currency. The merchant may send a message to the user indicating the exchange rate so that the user can determine whether the user still wishes to pay via foreign currency.

In some embodiments, the bill that is transmitted to the user (either a physical bill or electronic bill) comprises readable indicia (e.g., Quick Response (QR) code, barcode, radio frequency identification (RFID) tag, near field communication (NFC) tag, etc.). When the readable indicia (e.g., RFID tag, NFC tag, etc.) is scanned by the mobile device or when an image of the readable indicia (e.g., QR code, barcode, etc.) is captured by the mobile device, information regarding the bill may be loaded and/or processed by the mobile device. This information includes the bill name, bill identification number, merchant associated with the bill, bill due date, bill payment options, bill amount, past due amount, previous overpayments, etc. The mobile device may add the bill to the various user interfaces described herein either with or without user confirmation.

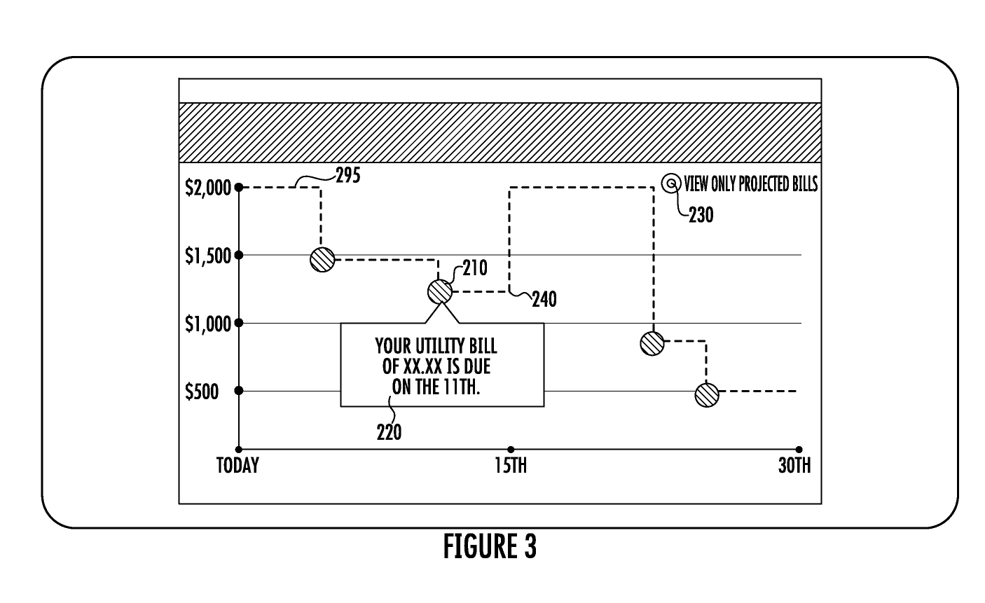

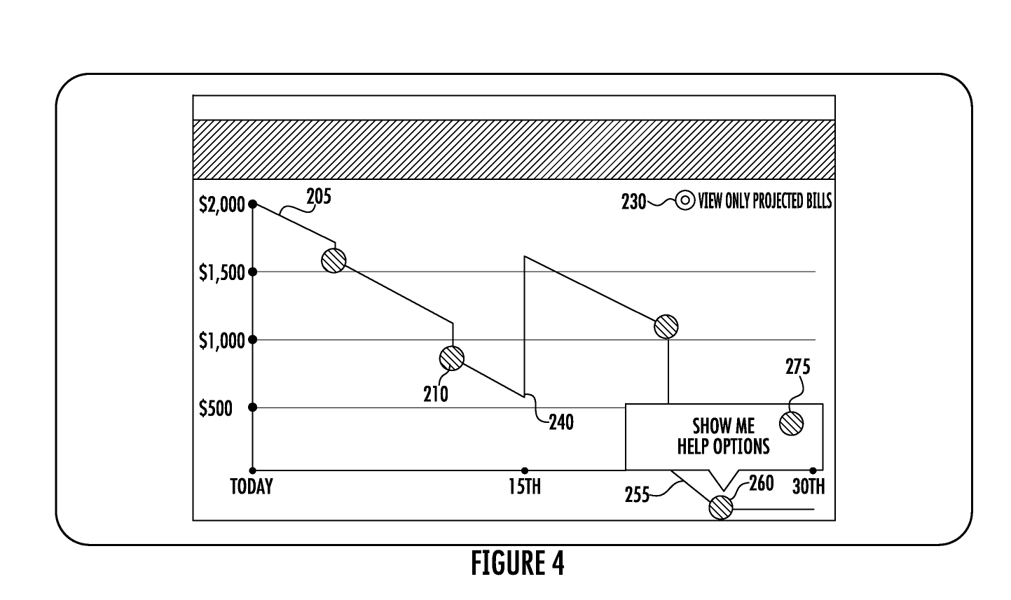

Referring now to FIG. 3, FIG. 3 is another user interface presenting a future view of an account when the user selects the option to view only projected bills, in accordance with embodiments of the present invention. As indicated in FIG. 3, the user interface presents the graphical indicators 210 associated with predicted or scheduled bill payments for a predetermined period in the future (e.g., the next thirty days). In some embodiments, the account balance graph is hidden. In other embodiments, the account balance graph is modified. For example, the account balance graph is presented as a dotted line graph 295, and the account balance graph is generated based on the predicted or scheduled bills and predicted funds transfers. The account balance graph in FIG. 3 does not consider predicted expenses; however, in other embodiments, predicted expenses may also be considered when generating the account balance graph. Therefore the account balance decreases when the bill payment is made at node 210 on the account balance graph. Additionally, the account balance increases when a predicted transfer of funds is made into the account at node 240 on the account balance graph. Since the account balance graph does not consider predicted expenses, the account balance graph does not fall below zero similar to the account balance graphs presented in FIGS. 2 and 4. In some embodiments, when the user selects the option to view only projected bills, the dotted line graph 295 is presented as overlapping the original account balance graph.

In embodiments where the user selects the option to view only projected expenses, the user interface presents graphical indicators associated with predicted expenses. Additionally, the account balance graph may be hidden or modified. When the account balance graph is modified, the account balance graph may be generated as a dotted line graph based on predicted expenses and predicted funds transfers into the account, and without considering predicted or scheduled bill payments.

In embodiments where the user selects the option to view only projected funds transfers into the account, the user interface presents graphical indicators associated with predicted funds transfers into the account. Additionally, the account balance graph may be hidden or modified. When the account balance graph is modified, the account balance graph may be generated as a dotted line graph based on predicted funds transfers into the account, and without considering predicted expenses and/or predicted or scheduled bill payments.

Referring now to FIG. 4, FIG. 4 is another user interface presenting a future view of an account, in accordance with embodiments of the present invention. In some embodiments, the account balance graph is selectable. For example, the user may select the account balance graph by touching the account balance graph, clicking on the account balance graph, or hovering over the account balance graph for a predetermined period of time. When the user selects the part 255 of the account balance graph associated with the period of time when the account balance is equal to or less than a predetermined threshold (e.g., zero), the system initiates presentation of a help option 275. Selecting the help option 275 initiates presentation of one or more options to assist the user with bill payments to be made and/or expenses to be satisfied until the next funds transfer into the account that causes the account balance to rise to a level greater than the predetermined threshold (e.g., zero or a balance greater than zero). In some embodiments, one of the options is an option to borrow funds (e.g., a bridge loan) from the financial institution until the next funds transfer(s) into the account that causes the account balance to rise to a level greater than the predetermined threshold (e.g., zero or a balance greater than zero). When the user selects the option (e.g., the bridge loan option), the user may be transported to a user interface that presents information regarding the bridge loan. For example, the information may comprise the amount of the bridge loan, the duration of the bridge loan, the interest rate associated with the bridge loan, the terms associated with making payments associated with the bridge loan, etc. Additionally, the information may provide instructions on how to obtain the bridge loan.

In some embodiments, one of the options is an option to transfer funds from another account (e.g., a savings account) to the account under consideration so that the balance in the account under consideration rises to a level greater than the predetermined threshold (e.g., zero or a balance greater than zero). When the user selects the option (e.g., the transfer funds option), the user may be transported to a user interface that prompts the user to select an amount of funds to transfer. Alternatively, when the user selects the option, a predetermined amount of funds is automatically transferred from the other account to the account under consideration. The amount of funds may be either transferred immediately or at a predetermined time in the future (e.g., prior to the account balance falling below the predetermined threshold).

In some embodiments, when the user selects a predicted or scheduled bill payment 260 that falls on the part of the account balance graph associated with the period of time when the account balance is equal to or less than a predetermined threshold, the user interface presents at least one of information regarding the bill (described previously) or the help option 275 also described previously.

In some embodiments, an option is presented on the user interface to automatically optimize scheduling of bill payment dates. In such embodiments, when the user selects the option to automatically optimize scheduling of bill payment dates, the system configures the scheduling of the bill payment dates for a predetermined period in the future (e.g., the next month) based on information regarding each bill (amount, due date, etc.), and based on predicted expenses and predicted funds transfers into the account. The system optimizes the scheduling of the bill payment dates (e.g., shifts the bill payment dates) such that the account balance does not fall below a predetermined threshold (e.g., zero) and such that each bill is paid by the bill's due date. In instances where the system determines that falling below the predetermined threshold is unavoidable, the system initiates presentation of a bridge loan option (or a funds transfer option) on the user interface as described herein. If the system determines that the account balance will be greater than a predetermined threshold for a predetermined period of time (e.g., a cushion balance) after considering the bill payments, expenses, and funds transfers, the system may optimize the balance by moving some funds to an investment account (e.g., an interest earning account).

Additionally, in some embodiments, the system may be configured to assign a weightage to each bill payment and expense. The weightage may be assigned based on preferences that a user inputs into the system. For example, the user may assign a high priority to a first bill payment and a low priority to a second bill payment. Therefore, the system configures the bill payment dates to make funds available for the first bill payment to be made. The system makes this possible by transferring funds from another account (e.g., savings account) or by delaying other low priority bill payments so that the first bill payment can be made on or before the due date. For the second low priority bill payment, the system determines whether funds are available to make this bill payment after funds have been arranged for all the high priority bill payments during a predetermined period. If sufficient funds are not available for the low priority bill payment, this bill payment may be delayed until the next funds transfer into the account. Therefore, the system establishes a priority hierarchy for the scheduled bill payments and predicted expenses.

In some embodiments, the system described herein initiates presentation of account suggestions (e.g., interest earning or investment suggestions) to optimize the use of funds in the account. For example, if the balance will be greater than a predetermined threshold amount for a predetermined period of time (e.g., a cushion balance) after considering the bill payments, expenses, and funds transfers, when the user selects the portion of the account balance graph where the account balance is greater than the predetermined threshold amount, the system may initiate an investment suggestion. The system may initiate a suggestion to move some funds to an investment account (e.g., an interest earning account). In some embodiments, a separate option may be presented on the user interface to optimize use of funds in the account.

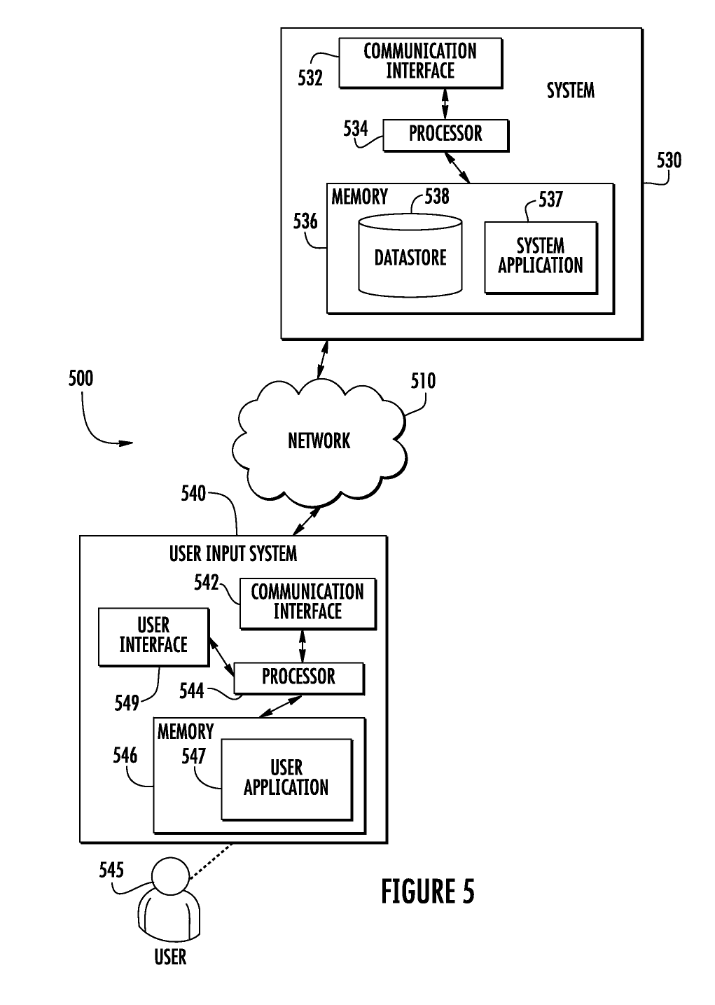

Referring now to FIG. 5, FIG. 5 presents an exemplary block diagram of the system environment 500 for implementing the process flow 100 described in FIG. 1, in accordance with embodiments of the present invention. As illustrated, the system environment 500 includes a network 510, a system 530, and a user input system 540. Also shown in FIG. 5 is a user 545 of the user input system 540. The user input system 540 may be a mobile device described herein. The user 545 may be a person who uses the user input system 540 to execute a user application 547. The user application 547 may be an application to access a financial institution account or a future view service associated with the financial institution account. The future view service or capability incorporates the features described herein. For example, the future view service enables presentation of the user interfaces described previously. The user application 547 and/or the system application 537 may incorporate one or more parts of the process flow 100.

As shown in FIG. 5, the system 530, and the user input system 540 are each operatively and selectively connected to the network 510, which may include one or more separate networks. In addition, the network 510 may include a local area network (LAN), a wide area network (WAN), and/or a global area network (GAN), such as the Internet. It will also be understood that the network 510 may be secure and/or unsecure and may also include wireless and/or wireline and/or optical interconnection technology.

The user input system 540 may include any computerized apparatus that can be configured to perform any one or more of the functions of the user input system 540 described and/or contemplated herein. For example, the user 545 may use the user input system 540 to transmit and/or receive information or commands to and from the system 530. In some embodiments, for example, the user input system 540 may include a personal computer system, a mobile computing device, a personal digital assistant, a mobile phone, a network device, and/or the like. As illustrated in FIG. 5, in accordance with some embodiments of the present invention, the user input system 540 includes a communication interface 542, a processor 544, a memory 546 having an user application 547 stored therein, and a user interface 549. In such embodiments, the communication interface 542 is operatively and selectively connected to the processor 544, which is operatively and selectively connected to the user interface 549 and the memory 546. In some embodiments, the user 545 may use the user application 547 to execute processes described with respect to the process flows described herein.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information.

Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the user interface 549. In some embodiments, the user interface 549 includes one or more output devices, such as a display and/or speaker, for presenting information to the user 545. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 545. In some embodiments, the user interface 549 includes the input and display devices of a mobile device, which are operable to receive and display information.

FIG. 5 also illustrates a system 530, in accordance with an embodiment of the present invention. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the financial institution. In some embodiments, such as the one illustrated in FIG. 5, the system 530 includes a communication interface 532, a processor 534, and a memory 536, which includes a system application 537 and a datastore 538 stored therein. As shown, the communication interface 532 is operatively and selectively connected to the processor 534, which is operatively and selectively connected to the memory 536.

It will be understood that the system application 537 may be configured to implement any one or more portions of the various user interfaces and/or process flow described herein. The system application 537 may interact with the user application 547. It will also be understood that, in some embodiments, the memory includes other applications. It will also be understood that, in some embodiments, the system application 537 is configured to communicate with the datastore 538, the user input system 540, etc.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the datastore 538. As used herein, the datastore 538 may be one or more distinct and/or remote datastores. In some embodiments, the datastore 538 is not located within the system and is instead located remotely from the system. In some embodiments, the datastore 538 stores information or data described herein. For example, the datastore 538 may store information associated with the user's financial institution account, bills, due dates associated with bills, etc.

It will be understood that the datastore 538 may include any one or more storage devices, including, but not limited to, datastores, databases, and/or any of the other storage devices typically associated with a computer system. It will also be understood that the datastore 538 may store information in any known way, such as, for example, by using one or more computer codes and/or languages, alphanumeric character strings, data sets, figures, tables, charts, links, documents, and/or the like. Further, in some embodiments, the datastore 538 may include information associated with one or more applications, such as, for example, the system application 537. It will also be understood that, in some embodiments, the datastore 538 provides a substantially real-time representation of the information stored therein, so that, for example, when the processor 534 accesses the datastore 538, the information stored therein is current or substantially current.

In alternate embodiments, the system 530 may be managed by the merchant, and not the financial institution. In some embodiments, there may be a system 530 managed by the merchant, and a separate system 530 managed by the financial institution. In some embodiments, the network 510 is a network to transmit information to and/or receive information from the merchant, and not the financial institution. Therefore in some embodiments, there may be a network 510 for the user input system 540 to communicate with the merchant, and a separate network 510 for the user input system 540 to communicate with the financial institution.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flow 100 described and/or contemplated herein in connection with FIG. 1 or any other process flow described herein. Additionally, the system 530 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

This application incorporates by reference in their entirety each of the following applications filed concurrently herewith:

U.S. application Ser. No. ______, entitled BILL CONTROL, filed Jul. 6, 2012 to Carrie Hanson et al. (Atty. Dkt. 5163US1.014033.1650);

U.S. application Ser. No. ______, entitled ELECTRONIC PROCESSING OF PAPER INVOICES, filed Jul. 6, 2012 to Carrie Hanson et al. (Atty. Dkt. 5168US1.014033.1660);

U.S. application Ser. No. ______, entitled FINANCIAL DOCUMENT PROCESSING SYSTEM, filed Jul. 6, 2012 to Carrie Hanson et al. (Atty. Dkt. 5169US1.014033.1661);

U.S. application Ser. No. ______, entitled TRANSACTION MONITORING AND SAVINGS FEATURE, filed Jul. 6, 2012 to Carrie Hanson et al. (Atty. Dkt. 5172US1.014033.1663);

U.S. application Ser. No. ______, entitled BILL PAYMENT MANAGEMENT, filed Jul. 6, 2012 to Carrie Hanson et al. (Atty. Dkt. 5173US1.014033.1662);

U.S. application Ser. No. ______, entitled EARNING REWARDS VIA BILL PAYMENT, filed Jul. 6, 2012 to Carrie Hanson et al. (Atty. Dkt. 5174US1.014033.1649); and

U.S. application Ser. No. ______, entitled CALENDAR BILL PAYMENT MANAGEMENT, filed Jul. 6, 2012 to Carrie Hanson et al. (Atty. Dkt. 5190US1.014033.1652).

1. An apparatus for initiating presentation of a future view of an account, the apparatus comprising:
a memory;
a processor; and
a module stored in the memory, executable by the processor, and configured to:
determine, for a predetermined period in the future, at least one bill payment to be made using funds associated with the account;
initiate, via a mobile network, presentation of a first graphical indicator indicating the at least one bill payment;
determine, for the predetermined period in the future and based on previous funds transfers into the account, at least one funds transfer into the account;
initiate, via the mobile network, presentation of an account balance graph associated with the account based at least partially on the at least one bill payment and the at least funds transfer, wherein the account balance graph indicates the account balance during the predetermined period in the future; and
initiate, via the mobile network, presentation of a help option in response to the account balance graph indicating the account balance falls below a predetermined threshold balance during the predetermined period in the future;
in response to receiving a first input that selects the help option, initiate, via the mobile network, presentation of one or more options available to prevent the account balance from falling below the predetermined threshold, wherein the options include borrowing funds, and transferring funds from another account; and
in response to receiving a second input that selects one of the options, initiate, via the mobile network, presentation of information associated with the option including instructions for at least one of applying for a bridge loan and transferring funds from another account.

2. The apparatus of claim 1, wherein the module is further configured to:
determine, for the predetermined period in the future and based on previous expenses satisfied using funds associated with the account, at least one expense to be satisfied using funds associated with the account; and
initiate, via the mobile network, presentation of the account balance graph based at least partially on the at least one bill payment and the at least one expense.

3. The apparatus of claim 2, wherein the module is further configured to:
initiate, via the mobile network, presentation of a second graphical indicator indicating the at least one expense.

4. (canceled)

5. The apparatus of claim 4, wherein the module is further configured to:
initiate, via the mobile network, presentation of a third graphical indicator indicating the at least one funds transfer into the account.

6. The apparatus of claim 1, wherein the at least one bill payment is determined based on previous bill payments made using funds associated with the account.

7. The apparatus of claim 1, wherein the at least one bill payment is determined based on manual input.

8. The apparatus of claim 1, wherein the at least one bill payment is determined based on an established electronic link between the account and a merchant.

9. The apparatus of claim 1, wherein when the first graphical indicator is selected, the module is configured to initiate presentation of information associated with the at least one bill payment, the information comprising at least one of a description associated with the bill payment, a due date associated with the bill payment, or an amount associated with the bill payment.

10. The apparatus of claim 1, wherein the module is further configured to initiate presentation of a fourth graphical indicator, wherein when the fourth graphical indicator is selected, the module is configured to: initiate presentation of the first graphical indicator indicating the at least one bill payment; and modify the account balance graph.

11. The apparatus of claim 10, wherein modifying the account balance graph comprises hiding the account balance graph.

12. The apparatus of claim 1, wherein initiate presentation of the one or more options available to prevent the account balance from falling below the predetermined threshold, wherein the options include borrowing funds under bridge loan for a predetermined loan period.

13. The apparatus of claim 12, wherein the predetermined loan period extends until the account is determined to receive an amount of funds causing the account balance to rise above the predetermined threshold balance.

14. The apparatus of claim 12, wherein the module is configured to initiate presentation of the option to select the bridge loan for the predetermined loan period when the user selects at least one of a portion of the account balance graph corresponding to the account balance falling below the predetermined threshold balance or a bill payment indicator located on the portion of the account balance graph corresponding to the account balance falling below the predetermined threshold balance.

15. (canceled)

16. The apparatus of claim 4, wherein the module is further configured to initiate presentation of a fifth graphical indicator, wherein when the fifth graphical indicator is selected, the module is configured to: initiate presentation of the second graphical indicator indicating the at least one expense; and modify the account balance graph.

17. The apparatus of claim 5, wherein the module is further configured to initiate presentation of a sixth graphical indicator, wherein when the sixth graphical indicator is selected, the module is configured to: initiate presentation of the third graphical indicator indicating the at least one funds transfer into the account; and modify the account balance graph.

18. The apparatus of claim 1, wherein the module is further configured to initiate presentation of at least one suggestion to optimize use of funds associated with the account.

19. A method for initiating presentation of a future view of an account, the method comprising:
determining, using a computer processing device, for a predetermined period in the future, at least one bill payment to be made using funds associated with the account;
initiating, using a computer processing device, via a mobile network, presentation of a graphical indicator indicating the at least one bill payment;
determining, using a computer processing device, for the predetermined period in the future and based on previous funds transfers into the account, at least one funds transfer into the account;
initiating, using a computer processing device, via the mobile network, presentation of an account balance graph associated with the account based at least partially on the at least one bill payment and the at least funds transfer, wherein the account balance graph indicates the account balance during the predetermined period in the future;
initiating, using a computing processing device, via the mobile network, presentation of a help option in response to the account balance graph indicating the account balance falls below a predetermined threshold balance during the predetermined period in the future;
in response to receiving a first input that selects the help option, initiating, using a computing device processor, via the mobile network, presentation of one or more options available to prevent the account balance from falling below the predetermined threshold, wherein the options include borrowing funds, and transferring funds from another account; and
in response to receiving a second input that selects one of the options, initiating, using a computing device processor, via the mobile network, presentation of information associated with the option including instructions for at least one of applying for a bridge loan and transferring funds from another account.

20. A computer program product for initiating presentation of a future view of an account, the computer program product comprising:
a non-transitory computer-readable medium comprising a set of codes for causing a computer to:
determine, for a predetermined period in the future, at least one bill payment to be made using funds associated with the account;
initiate, via a mobile network, presentation of a graphical indicator indicating the at least one bill payment;
determine, for the predetermined period in the future and based on previous funds transfers into the account, at least one funds transfer into the account;
initiate, via the mobile network, presentation of an account balance graph associated with the account based at least partially on the at least one bill payment and the at least funds transfer, wherein the account balance graph indicates the account balance during the predetermined period in the future;
initiate, via the mobile network, presentation of a help option in response to the account balance graph indicating the account balance falls below a predetermined threshold balance during the predetermined period in the future;
in response to receiving a first input that selects the help option, initiate, via the mobile network, presentation of one or more options available to prevent the account balance from falling below the predetermined threshold, wherein the options include borrowing funds, and transferring funds from another account; and
in response to receiving a second input that selects one of the options, initiate, via the mobile network, presentation of information associated with the option including instructions for at least one of applying for a bridge loan and transferring funds from another account.
